(19) United States
(12) Patent Application Publication
(10) Pub. No.: US 2024/0075863 A1
(43) Pub. Date: Mar. 7, 2024

(54) TRAY ASSEMBLY FOR A VEHICLE

(71) Applicant: Ford Global Technologies, LLC, Dearborn, MI (US)

(72) Inventors: Martin Fassbender, Buschhoven (DE); Sascha Kaatz, Langenfeld (Rheinland) (DE); Philipp Kuepper, Grevenbroich (DE)

(73) Assignee: Ford Global Technologies, LLC, Dearborn, MI (US)

(21) Appl. No.: 18/456,055

(22) Filed: Aug. 25, 2023

(30) Foreign Application Priority Data
Sep. 1, 2022 (DE) 102022122107.5

(51) Int. Cl. B60N 3/00; B60Q 3/20; B60R 16/03; B62D 1/06; B62D 1/10

(52) U.S. Cl. CPC B60N 3/005; B60Q 3/20; B60R 16/03; B62D 1/06; B62D 1/10

(57) ABSTRACT

A tray assembly for a vehicle has a steering wheel rim and a plate-shaped tray unit arranged on the steering wheel rim. The steering wheel rim is mounted to be pivotable about a horizontal pivot axis between a steering position and a tray position arranged at a smaller angle of inclination than in the steering position. In order to provide a tray assembly which can be handled in a manner which is reliable in operation and user-friendly, an edge of the tray unit is matched to a profile of the steering wheel rim such that the tray unit arranged on the steering wheel rim located in the tray position partially or completely covers the steering wheel rim from above, without projecting beyond the steering wheel rim on the outside.

### CROSS-REFERENCE TO RELATED APPLICATION

This application claims foreign priority benefits under 35 U.S.C. § 119(a)-(d) to German Application No. 102022122107.5 filed Sep. 1, 2022, which is hereby incorporated by reference in its entirety.

### FIELD OF THE DISCLOSURE

The present disclosure generally relates to a tray assembly for a vehicle and, more particularly, to a tray assembly, which can be arranged on the steering wheel rim.

### BACKGROUND OF THE DISCLOSURE

It is generally known to arrange a steering wheel rim or an entire steering wheel of a vehicle when the vehicle is not driven to be pivotable about a horizontal pivot axis between a steering position and a tray position. In the tray position, the steering wheel rim is typically arranged at a smaller angle of inclination than in the steering position. Arranging the steering wheel rim or steering wheel in the tray position enables the steering wheel rim or steering wheel or a tray arranged thereon to form a tray surface for holding or supporting objects, e.g., in order to provide a tray surface for food, for example. Moreover, arranging the steering wheel rim or steering wheel in the tray position makes it possible to free up a space, thereby making it easier for the driver to get in and out. On the tray surface thus formed, which can be aligned at a slight inclination or horizontally, it is possible to set down or deposit objects, e.g., a laptop, a tablet, or the like.

When a vehicle is not being driven, it may be desirable to provide a tray assembly on a steering wheel, which can be handled in an effective and user-friendly manner.

### SUMMARY OF THE DISCLOSURE

According to a first aspect of the present disclosure, a tray assembly for a vehicle comprises a steering wheel rim and a plate-shaped tray unit configured to be arranged on the steering wheel rim, where the steering wheel rim is mounted to be pivotable about a horizontal pivot axis between a steering position and a tray position, in which the steering wheel rim is arranged at a smaller angle of inclination than in the steering position, where an edge of the tray unit is matched to a profile of the steering wheel rim such that the tray unit arranged on the steering wheel rim located in the tray position partially or completely covers the steering wheel rim from above, without projecting beyond the steering wheel rim on an outside.

Embodiments of the first aspect of the present disclosure can include any one or a combination of the following features:
the edge of the plate-shaped tray unit is matched to the profile of the steering wheel rim such that the edge is arranged in a circumferential region with a maximum material thickness of the steering wheel rim located in the tray position;
the plate-shaped tray unit is configurable to be arranged on the steering wheel rim such that the plate-shaped tray unit is arranged partially below a plane defined by an upper side of the steering wheel rim located in the tray position;
the plate-shaped tray unit has at least one partially circumferential sealing lip, which contacts the steering wheel rim when the tray unit is arranged on the steering wheel rim located in the tray position;
an upper side of the plate-shaped tray unit, which upper side provides a tray surface, is at least partially of an anti-slip design;
the plate-shaped tray unit has at least one holding unit for temporarily holding an object;
the plate-shaped tray unit has at least one induction charging unit;
the plate-shaped tray unit has at least one integrated keyboard and/or at least one data interface and/or at least one touchpad and/or at least one coupling unit;
the plate-shaped tray unit has at least one lighting unit; and
the plate-shaped tray unit has at least one electrical supply connection for supplying electrical energy to at least one external device or internal device.

According to a second aspect of the present disclosure, a steering wheel for a vehicle comprises a steering wheel rim and a plate-shaped tray unit configured to be arranged on the steering wheel rim, where the steering wheel rim is mounted to be pivotable about a horizontal pivot axis between a steering position and a tray position, in which the steering wheel rim is arranged at a smaller angle of inclination than in the steering position, where an edge of the tray unit is matched to a profile of the steering wheel rim such that the tray unit arranged on the steering wheel rim located in the tray position partially or completely covers the steering wheel rim from above, without projecting beyond the steering wheel rim on an outside.

Embodiments of the second aspect of the present disclosure can include any one or a combination of the following features:
the edge of the plate-shaped tray unit is matched to the profile of the steering wheel rim such that the edge is arranged in a circumferential region with a maximum material thickness of the steering wheel rim located in the tray position;
the plate-shaped tray unit is configurable to be arranged on the steering wheel rim such that the tray unit is arranged partially below a plane defined by an upper side of the steering wheel rim located in the tray position;
the plate-shaped tray unit has at least one partially circumferential sealing lip, which contacts the steering wheel rim when the plate-shaped tray unit is arranged on the steering wheel rim located in the tray position;
the plate-shaped tray unit, which upper side provides a tray surface, is at least partially of an anti-slip design;
the plate-shaped tray unit has at least one holding unit for temporarily holding an object;
the plate-shaped tray unit has at least one induction charging unit;
the plate-shaped tray unit has at least one integrated keyboard and/or at least one data interface and/or at least one touchpad and/or at least one coupling unit;
the plate-shaped tray unit has at least one lighting unit; and
the plate-shaped tray unit has at least one electrical supply connection for supplying electrical energy to at least one external device or internal device.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a schematic and perspective illustration of an exemplary embodiment of a tray assembly according to one embodiment;

FIG. 2a is a schematic sectional illustration of the tray assembly shown in FIG. 1;

FIG. 2b is a schematic plan view of a tray assembly according to a further exemplary embodiment;

FIG. 3a is a schematic and perspective illustration of a variant of the tray assembly shown in FIG. 1;

FIG. 3b is a schematic and perspective illustration of a further variant of the tray assembly shown in FIG. 1;

FIG. 4a is a schematic and perspective illustration of a tray assembly according to a further exemplary embodiment;

FIG. 4b is a further schematic and perspective illustration of the tray assembly shown in FIG. 4a;

FIG. 5a is a schematic and perspective illustration of a tray assembly according to a further exemplary embodiment;

FIG. 5b shows schematic sectional illustrations of the tray assembly shown in FIG. 5a;

FIG. 6 is a schematic and perspective illustration of a tray assembly according to a further exemplary embodiment; and

FIG. 7 is an enlarged perspective cutaway view illustrating further details of a tray unit.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The FIG.s are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

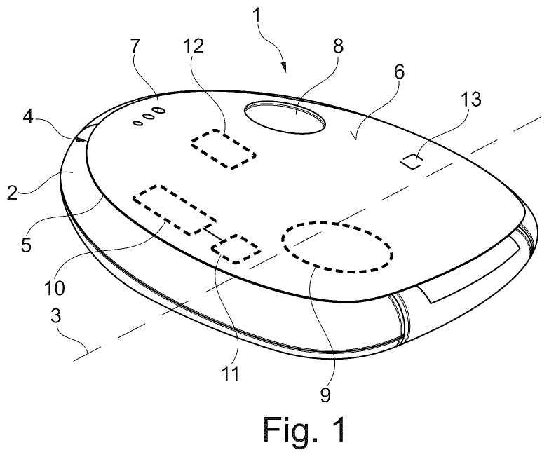

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a tray assembly for a vehicle. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

In the different figures, identical parts are provided with the same reference signs, for which reason they may generally also only be described once.

FIG. 1 shows a schematic and perspective illustration of an exemplary embodiment of a tray assembly 1 for a vehicle such as a motor vehicle having a steering wheel. It should be appreciated that the steering wheel has a steering wheel rim 2 configured to be engaged by the hands of a driver and rotated to steer the vehicle, e.g., vehicle wheels.

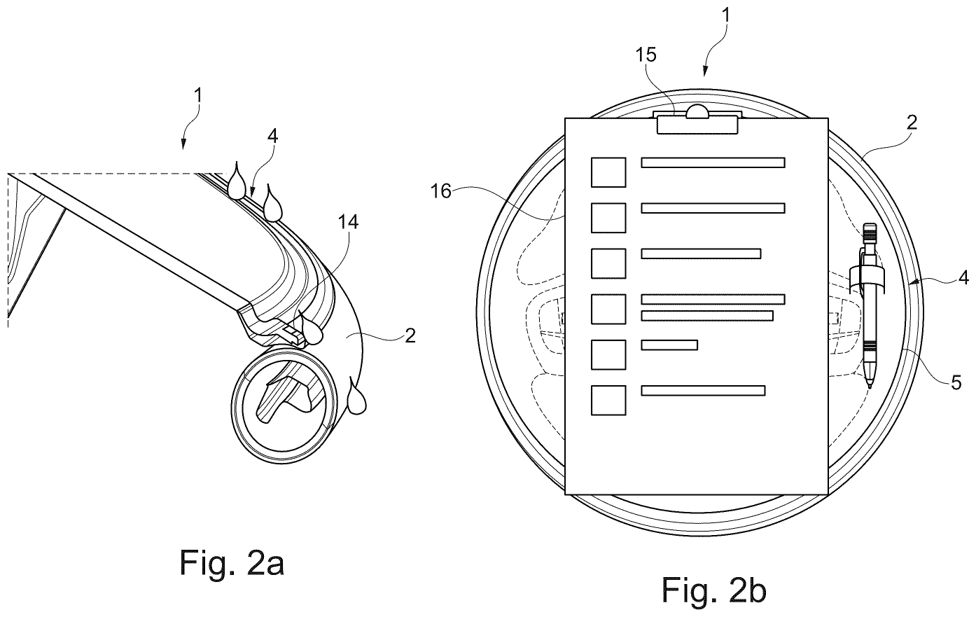

The tray assembly 1 has the steering wheel rim 2, which, with the exception of a flattened portion shown on the right in FIG. 1, is in the form of a circular ring. As normal, the steering wheel rim 2 has a substantially circular cross-sectional area, as shown in FIG. 2a. As a result, the steering wheel rim 2 has a circumferential region with the maximum material thickness which is arranged centrally on the steering wheel rim 2 with respect to a thickness direction of the steering wheel rim 2. The steering wheel rim 2 is mounted so as to be pivotable about a horizontal pivot axis 3 between a steering position and the tray position or deposition position shown in FIG. 1, in which the steering wheel rim 2 is arranged at a smaller angle of inclination than in the steering position. It should be appreciated that the vehicle may be locked-out in park and not moving when the tray assembly 1 is in the tray position.

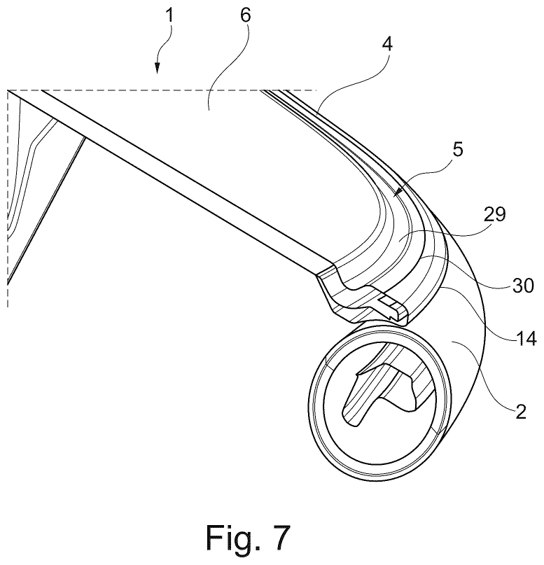

In addition, the tray assembly 1 has a tray unit 4, which is arranged on the steering wheel rim 2 and is of a plate-shaped design. An edge 5 of the tray unit 4 is matched to a profile of the steering wheel rim 2 in such a way that the tray unit 4 arranged on the steering wheel rim 2 located in the tray position partially covers, in particular half-covers, the steering wheel rim 2 from above, without projecting beyond the steering wheel rim 2 on the outside. In this case, the edge 5 of the tray unit 4 is matched to the profile of the steering wheel rim 2 in such a way that the edge 5 is arranged in the circumferential region with the maximum material thickness of the steering wheel rim 2 located in the tray position. In this case, the tray unit 4 is arranged on the steering wheel rim 2 in such a way that the tray unit 4 is arranged partially below an imaginary plane defined by an upper side (not shown) of the steering wheel rim 2 located in the tray position. An enlarged detail view of the tray unit 4 is shown in FIG. 7.

The tray unit 4 has a circumferential sealing lip 14 (shown in FIG. 2a), which contacts the steering wheel rim 2 when the tray unit 4 is arranged on the steering wheel rim 2 located in the tray position. In addition, an upper side 6 of the tray unit 4, which upper side provides a tray surface, is at least partially of an anti-slip design.

In addition, the tray unit 4 has three holding units 7 of different sizes for temporarily holding pens, wherein each of these holding units 7 is designed as a blind hole or as a through hole. Of course, the through hole is embodied in such a way that the pen to be received is held in a positionally stable manner. It is also possible to provide clamping elements. In addition, the tray unit 4 has a holding unit 8 in the form of a cupholder for temporarily holding a vessel, such as a cup or a glass. The holding unit 8 is designed as a circular depression or trough. This provides the vessel with further positional stability in addition to the anti-slip surface.

Furthermore, the tray unit 4 has a schematically indicated induction charging unit 9. In addition, the tray unit 4 can have at least one schematically indicated power bank 10 and at least one electrical, schematically indicated supply connection 11, connected to the power bank 10, for supplying at least one external device with electrical energy. Moreover, the tray unit 4 can have at least one schematically indicated photovoltaic unit 12 for charging the power bank 10.

Furthermore, the tray unit 4 can have at least one schematically indicated data interface 13, to which an external electronic device can be connected, for example in order to be able to connect the external device to the vehicle in terms of communication technology.

FIG. 2a shows a schematic sectional illustration of the tray assembly 1 shown in FIG. 1. In particular, it shows the sealing lip 14 of the tray unit 4, which rests against the steering wheel rim 2. The sealing lip 14 can assume multiple functions. On the one hand, the sealing lip 14 can contribute to the further positional stability of the tray unit 4 on the steering wheel rim 2. Furthermore, a sealing function can actually be assumed in order to protect the elements arranged in the steering wheel, e.g., airbag and/or switch or operating elements, from the entry of liquid which could spill over the tray unit once a vessel has fallen over. In addition, the sealing lip 14 can prevent scratching of the covering of the steering wheel rim 2.

FIG. 2b shows a schematic plan view of a further exemplary embodiment of a tray assembly 1 according to the disclosure. This tray assembly differs from the exemplary embodiment shown in FIGS. 1 and 2a only in that, alternatively or in addition, a holding unit 15 in the form of a clamping mechanism is present, as a result of which the tray unit 4 is designed in the manner of a clipboard. In FIG. 2b, the holding unit 15 holds a sheet 16, but can also hold a tablet or, for example, an e-book.

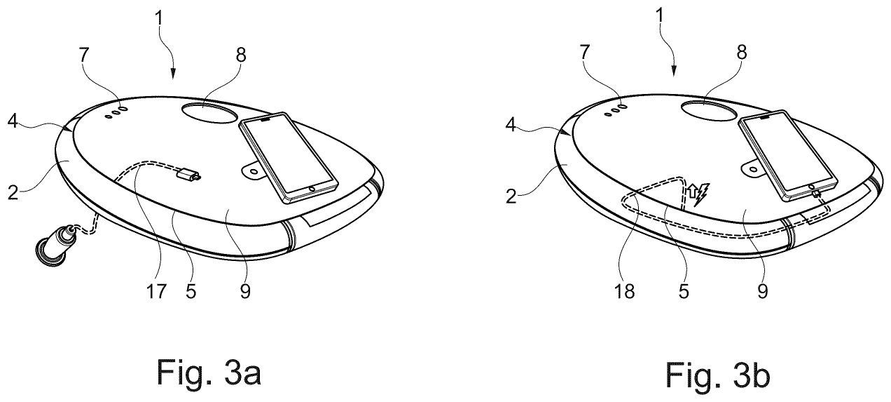

FIG. 3a shows a schematic and perspective illustration of a variant of the tray assembly 1 shown in FIG. 1. In this variant, the induction charging unit 9 is supplied with electrical energy via a USB cable 17, which for this purpose is connected to the vehicle at a suitable point by provided connecting sockets.

FIG. 3b shows a schematic and perspective illustration of a further variant of the tray assembly 1 shown in FIG. 1. In this variant, the induction charging unit 9 is supplied with electrical energy via a cable 18, which, for this purpose, can be guided via a steering wheel clock spring (not shown) into the steering wheel (not shown) having the steering wheel rim 2 and from there via a hidden connection (not shown) under a retaining flap (not shown) to the tray unit 4.

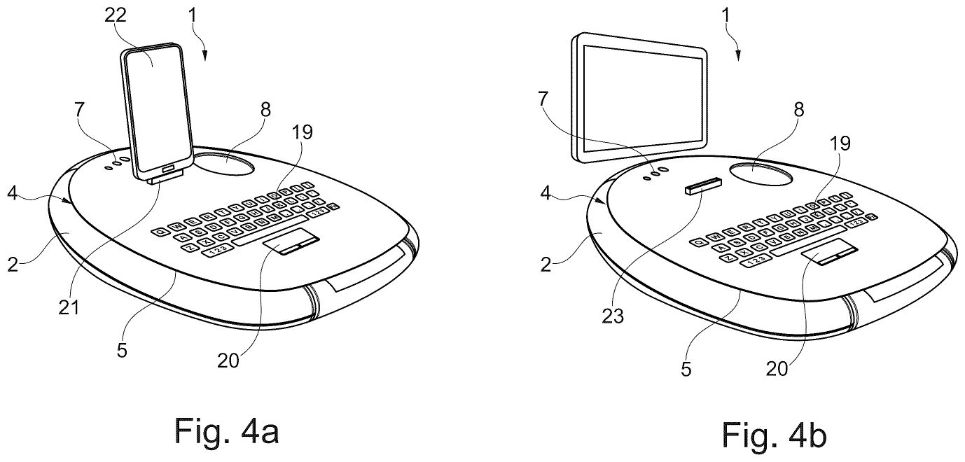

FIG. 4a shows a schematic and perspective illustration of a further exemplary embodiment of a tray assembly 1 according to the disclosure. This tray assembly 1 differs from the exemplary embodiment shown in FIGS. 1 and 2a in that the tray unit 4 has an integrated capacitive keyboard 19, a touchpad 20 and a coupling unit 21 for mechanically holding a data-processing device, such as, for example, a smartphone 22 or tablet.

FIG. 4b shows a further schematic and perspective illustration of the tray assembly 1 shown in FIG. 4a. Owing to the non-use of the coupling unit 21 shown in FIG. 4a, the coupling unit 21 is covered with a covering 23, which forms a portion of the upper side 6 of the tray unit 4.

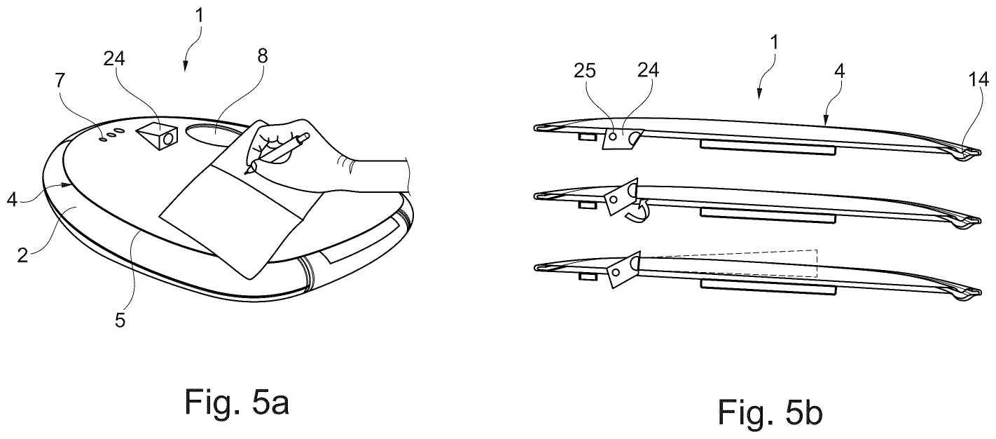

FIG. 5a shows a schematic and perspective illustration of a further exemplary embodiment of a tray assembly 1 according to the disclosure. This tray assembly 1 differs from the exemplary embodiment shown in FIGS. 1 and 2a in that the tray unit 4 has a lighting unit 24.

FIG. 5b shows schematic sectional illustrations of the tray unit 4 shown in FIG. 5a. In the upper illustration of FIG. 5b, the lighting unit 24 is in a recessed idle position, in which it forms a portion of the upper side 6 of the tray unit 4. In the middle illustration of FIG. 5b, the lighting unit 24 is shown in an intermediate position, into which the lighting unit 24 has moved by pivoting about a pivot axis 25 extending transversely to the plane of the drawing. In the lower illustration of FIG. 5b, the lighting unit 24 is shown in a functional position, in which the lighting unit 24 serves, for example, as a reading lamp. For this purpose, the lighting unit 24 has been pivoted even further about the pivot axis 25.

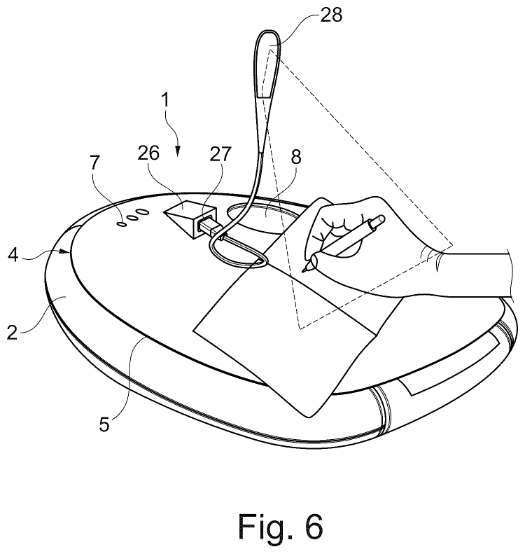

FIG. 6 shows a schematic and perspective illustration of a further exemplary embodiment of a tray assembly 1 according to the disclosure. This tray assembly 1 differs from the exemplary embodiment shown in FIGS. 5a and 5b in that, instead of the lighting unit, a correspondingly retractable connection unit 26 is provided, which provides an electrical supply connection 27 for the lamp 28 shown by way of example.

FIG. 7 shows an enlarged segment of the tray unit 4. In the left-hand plane of the drawing, the anti-slip upper side 6 can be seen, which is adjoined by the edge 5. The edge 5 has a circumferential groove-type depression 29, which is adjoined by a flange 30. As can be seen in the plane of the drawing of FIG. 7, the sealing lip 14 is arranged opposite the anti-slip upper side 6 on an underside of the edge 5, i.e., of the groove-type depression 29 and of the flange 30. As can further be seen, the sealing lip 14 is routed around the edge 5, or the flange 30 thereof, fitting around the latter, toward the upper side 6. FIG. 7 also shows a segment of the steering wheel rim 2, wherein it can be seen how the edge 5 is held in a positionally stable manner by its flange 30 on the steering wheel rim 2, covering up to half of the latter, and by its groove-type depression 29 within the steering wheel rim 2. The protective and sealing function of the sealing lip 14 is likewise visible from FIG. 7, wherein it can also be seen that the tray unit 4 does not project outward beyond the steering wheel rim 2.

According to the disclosure, a tray assembly is provided, wherein an edge of the tray unit is matched to a profile of the steering wheel rim in such a way that the tray unit arranged on the steering wheel rim located in the tray position partially or completely covers the steering wheel rim from above, without projecting beyond the steering wheel rim on the outside.

It should be noted that the features and measures presented individually in the disclosure can be combined with one another in any technically feasible manner and indicate further embodiments. The description additionally characterizes and specifies the tray assembly, in particular in conjunction with the figures.

According to the disclosure, it is envisaged that the tray unit arranged on the steering wheel rim located in the tray position does not project laterally or outward beyond the steering wheel rim. The absence of such an overlap namely prevents the user from accidentally raising the tray unit from the steering wheel rim with their hand or knee, which could lead to food or drink which has been placed on the tray unit, for example, sliding off the tray unit or tipping over, thereby being spilled into the interior of the vehicle. This would lead to contamination of the interior of the vehicle and could furthermore impair the user. Overall, the tray assembly is therefore more effective.

To achieve the described advantage of the disclosure, it is also not necessary to fasten the tray unit on the steering wheel rim by use of mechanical fasteners. This may only be necessary if the tray unit were to project laterally or outward beyond the steering wheel rim. Consequently, the tray assembly according to the disclosure can be produced in such a way as to be of simpler design and thus less expensive and to be arranged with less effort on the steering wheel rim, more particularly simply being laid on the steering wheel rim located in the tray or deposition position or being inserted therein.

The steering wheel rim can be in the form of a circular ring or can have a shape that deviates from a circular ring. For example, the steering wheel rim can have an approximately rectilinear portion on a lower side, which is arranged at the bottom or at the lowest point when the steering wheel rim is in the straight ahead position. The steering wheel rim can be arranged on a steering wheel hub of the steering wheel in such a way as to be pivotable about the horizontal pivot axis. Alternatively, the entire steering wheel can be arranged in a correspondingly pivotable manner. In the steering position, the steering wheel rim is arranged at a steeper inclination and can be used by the user to steer the vehicle. In the tray position, also referred to as the deposition position, the steering wheel rim is only slightly inclined or is aligned horizontally.

The tray unit is of plate-shaped design in the embodiment shown, which means that the tray unit has a low material thickness in comparison with the tray area provided by it.

The tray assembly can be used in various types of vehicles. In particular, the tray assembly can be used in motor vehicles in the form of a private motor vehicle or a truck or a commercial vehicle. Such a vehicle thus forms a further aspect of the present disclosure.

According to an advantageous embodiment, the edge of the tray unit is matched to the profile of the steering wheel rim in such a way that the edge is arranged in a circumferential region with a maximum material thickness of the steering wheel rim located in the tray position. As a result, the edge of the tray unit is matched to the profile of the steering wheel rim in such a way that the tray unit arranged on the steering wheel rim located in the tray position partially covers the steering wheel rim from above, without projecting beyond the steering wheel rim on the outside. Normally, a steering wheel rim has a circular or preferably even elliptical cross-sectional area, and therefore the circumferential region with the maximum material thickness with regard to a thickness of the steering wheel rim is generally central or at the apex of the principal axis of the ellipse. The tray unit can be matched to the shape of the steering wheel rim in such a way that the edge of the tray unit can be arranged approximately flush with the circumferential region of the maximum material thickness, ensuring that the tray unit does not project or projects only insignificantly upward from the steering wheel rim. In this case, the majority of the tray unit is thus situated in an interspace enclosed by the steering wheel rim, and therefore the tray unit is as it were inserted into this interspace and, at the same time, rests on top of the circumferential region with the maximum material thickness.

According to a further advantageous embodiment, the tray unit can be or is arranged on the steering wheel rim in such a way that the tray unit is arranged partially below a plane defined by an upper side of the steering wheel rim located in the tray position. This enables the tray unit to be inserted easily into the steering wheel rim. That portion of the tray unit which is situated below the plane defined by the upper side of the steering wheel rim located in the tray position can have an outer contour matched to the steering wheel rim, in particular to enable the tray unit to be inserted with a positive fit into the steering wheel rim. This can be achieved, for example, by providing a circumferential groove-type depression, which is adjoined on the outside by a flange which rests on the steering wheel rim. The circumferential groove-type depression can thus have several functions. On the one hand, like a spring element, it can bring about a required clamping force, which is caused when the tray unit is inserted into the steering wheel rim. On the other hand, the groove-type depression can serve as a collecting element for any liquid which has been spilled. The tray unit can also be arranged very largely below the plane defined by the upper side of the steering wheel rim located in the tray position.

According to a further advantageous embodiment, the tray unit has at least one partially circumferential sealing lip, which contacts the steering wheel rim when the tray unit is arranged on the steering wheel rim located in the tray position. The sealing lip can be produced from a composite material or from an elastic material, for example. The sealing lip can be used to ensure that a liquid spilled on the tray unit cannot reach a steering wheel airbag or steering wheel switches. By this arrangement, the effectiveness of the tray assembly is increased. By the gentle contact of the tray unit with the steering wheel rim, preferably exclusively via the sealing lip, it is furthermore possible to protect the surface of the steering wheel rim, which may be formed from leather, for example, from liquid penetration. In a further advantageous embodiment, the sealing lip can be elastic, i.e., flexible, enabling it to adapt easily to depressions arranged in the steering wheel rim, e.g., recesses or protrusions or even an undulating profile, e.g., for fingers. The elasticity of the sealing lip also leads to a certain spring force being present for the further positionally stable arrangement of the tray unit on or in the steering wheel rim. In one embodiment, the sealing lip is arranged on the rim below the groove-type depression and the flange, fitting over the latter. If the sealing lip is furthermore embodied like a bead, this can have sufficient potential to bring about an even more positionally stable arrangement of the tray unit when the tray unit is inserted or fitted into the steering wheel rim, bringing about an additional clamping force.

According to a further advantageous embodiment, an upper side of the tray unit, which upper side provides a tray surface, is at least partially of an anti-slip design. This is advantageous especially if the tray unit is arranged in an inclined manner when the steering wheel rim is in the tray position. Here, the anti-slip property of the upper side of the tray unit makes it possible to prevent an object, e.g., hot food or a hot drink, from slipping off the tray unit and being spilled.

According to a further advantageous embodiment, the tray unit has at least one holding unit for temporarily holding an object. The holding unit can be designed to hold a pen, a cup, a glass, or the like. A pen holding unit can be designed as a clip or as an insertion opening on the tray unit, for example. A cup and glass holding unit can be designed as a surface depression on the tray unit, for example. The holding unit can be designed as a clamping unit, for example, with the result that the tray unit is designed as a clipboard. This enables the tray unit also to be used as a clipboard outside the vehicle. The use of the tray unit outside the vehicle, including in combination with the clamping unit, can also be envisaged for the advantageous embodiments that follow or have already been described.

According to a further advantageous embodiment, the tray unit has at least one induction charging unit. This enables the tray unit or tray assembly to be used for electrical charging of a mobile terminal, e.g., a smart phone, a tablet or a laptop. For this purpose, the tray unit can be designed in such a way that it has a specific induction charging region or that induction charging can take place over its entire surface. The induction charging unit can have, for example, at least one power bank, which can be partially or completely integrated into the tray unit. The power bank can be electrically charged, for example, when the tray unit is not arranged on the steering wheel rim and is being stored in a storage compartment, possibly provided for this purpose, in the vehicle, for example next to a driver's seat. The tray unit can have at least one solar cell unit integrated into the tray unit, via which the power bank can also be electrically charged, wherein power could also be supplied to the tray unit, that is to say to the elements integrated therein or connected thereto. In addition, the tray unit can have at least one display unit for displaying the state of charge of the power bank.

According to a further advantageous embodiment, the tray unit has at least one integrated keyboard and/or at least one data interface and/or at least one touchpad. The keyboard and/or touchpad can be illuminated, especially when they are in use. The keyboard can be provided with capacitive keys, for example. The keyboard, and also the touch pad, can have, for example, a Bluetooth interface, or other interfaces that can transmit data, or the like, wirelessly, to enable it to be connected to further electronic devices, including those in the vehicle. The keyboard can be used, for example, to type or work on a smartphone or a tablet PC or a vehicle cluster, that is to say also on an instrument cluster. If there is an internet connection, it can be used in full, and even visualized. The tray unit can have at least one mechanical coupling unit, to which an electronic terminal, such as a smartphone, or a tablet, can be coupled and on which the data interface can be arranged. The coupling unit can expediently be used both for charging and for data exchange with the integrated touchpad or the integrated keyboard. When not in use, the coupling unit can be covered by a covering of the tray unit. The tray unit is available for multifunction office capability; i.e., it can be used as if it were as a mobile office. Of course, the tray unit can also be used outside the vehicle.

According to a further advantageous embodiment, the tray unit has at least one lighting unit. The lighting unit can be used as a reading lamp, for example. The lighting unit can, for example, be arranged in a retractable manner on the tray unit in order to be movable or to be moved from an extended functional position into a retracted idle position, and vice versa. When the lighting unit is in the idle position, the surface of the tray unit is not restricted by the presence of the lighting unit.

According to a further advantageous embodiment, the tray unit has at least one electrical supply connection for supplying electrical energy to at least one external, or internal, device. For the purposes of the disclosure, an internal device is an element integrated into the tray unit, wherein an external device is a device which can be connected to the tray unit and/or can be supported on or against the latter. The supply connection can be a USB connection, for example. Via the supply connection, it is possible, for example, to supply a charger, a lamp, a fan, or the like, with electrical energy. In addition to embodying the tray unit with a power bank, the tray unit can be connected via a USB cable to a USB charging connection of the vehicle to enable the electrical supply connection to be supplied with electrical energy. If the tray unit is used externally, the USB connection can of course be connected to any suitable power supply connection. If, in addition, an induction charging unit is present on the tray unit, a cable provided for supplying the induction charging unit with electrical energy can be passed via a steering wheel clock spring into the steering wheel and from there, via a hidden connection under a retaining flap, to the tray unit.

In an ideal embodiment, the tray unit can also have a display or a monitor. In this case, complete integration of these elements is expedient, and a folding design is also conceivable, enabling said elements, when in use, to be transferred from a non-use position into a use position and, when not in use, to be transferred back.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A tray assembly for a vehicle, the tray assembly comprising:
a steering wheel rim; and
a plate-shaped tray unit configured to be arranged on the steering wheel rim, wherein the steering wheel rim is mounted to be pivotable about a horizontal pivot axis between a steering position and a tray position, in which the steering wheel rim is arranged at a smaller angle of inclination than in the steering position, wherein an edge of the tray unit is matched to a profile of the steering wheel rim such that the tray unit arranged on the steering wheel rim located in the tray position partially or completely covers the steering wheel rim from above, without projecting beyond the steering wheel rim on an outside.

2. The tray assembly according to claim 1, wherein the edge of the plate-shaped tray unit is matched to the profile of the steering wheel rim such that the edge is arranged in a circumferential region with a maximum material thickness of the steering wheel rim located in the tray position.

3. The tray assembly according to claim 1, wherein the plate-shaped tray unit is configurable to be arranged on the steering wheel rim such that the plate-shaped tray unit is arranged partially below a plane defined by an upper side of the steering wheel rim located in the tray position.

4. The tray assembly according to claim 1, wherein the plate-shaped tray unit has at least one partially circumferential sealing lip, which contacts the steering wheel rim when the tray unit is arranged on the steering wheel rim located in the tray position.

5. The tray assembly according to claim 1, wherein an upper side of the plate-shaped tray unit, which upper side provides a tray surface, is at least partially of an anti-slip design.

6. The tray assembly according to claim 1, wherein the plate-shaped tray unit has at least one holding unit for temporarily holding an object.

7. The tray assembly according to claim 1, wherein the plate-shaped tray unit has at least one induction charging unit.

8. The tray assembly according to claim 1, wherein the plate-shaped tray unit has at least one integrated keyboard and/or at least one data interface and/or at least one touchpad and/or at least one coupling unit.

9. The tray assembly according to claim 1, wherein the plate-shaped tray unit has at least one lighting unit.

10. The tray assembly according to claim 1, wherein the plate-shaped tray unit has at least one electrical supply connection for supplying electrical energy to at least one external device or internal device.

11. A steering wheel for a vehicle, the steering wheel comprising:
a steering wheel rim; and
a plate-shaped tray unit configured to be arranged on the steering wheel rim, wherein the steering wheel rim is mounted to be pivotable about a horizontal pivot axis between a steering position and a tray position, in which the steering wheel rim is arranged at a smaller angle of inclination than in the steering position, wherein an edge of the tray unit is matched to a profile of the steering wheel rim such that the tray unit arranged on the steering wheel rim located in the tray position partially or completely covers the steering wheel rim from above, without projecting beyond the steering wheel rim on an outside.

12. The steering wheel according to claim 11, wherein the edge of the plate-shaped tray unit is matched to the profile of the steering wheel rim such that the edge is arranged in a circumferential region with a maximum material thickness of the steering wheel rim located in the tray position.

13. The steering wheel according to claim 11, wherein the plate-shaped tray unit is configurable to be arranged on the steering wheel rim such that the tray unit is arranged partially below a plane defined by an upper side of the steering wheel rim located in the tray position.

14. The steering wheel according to claim 11, wherein the plate-shaped tray unit has at least one partially circumferential sealing lip, which contacts the steering wheel rim when the plate-shaped tray unit is arranged on the steering wheel rim located in the tray position.

15. The steering wheel according to claim 11, wherein an upper side of the plate-shaped tray unit, which upper side provides a tray surface, is at least partially of an anti-slip design.

16. The steering wheel according to claim 11, wherein the plate-shaped tray unit has at least one holding unit for temporarily holding an object.

17. The steering wheel according to claim 11, wherein the plate-shaped tray unit has at least one induction charging unit.

18. The steering wheel according to claim 11, wherein the plate-shaped tray unit has at least one integrated keyboard and/or at least one data interface and/or at least one touchpad and/or at least one coupling unit.

19. The steering wheel according to claim 11, wherein the plate-shaped tray unit has at least one lighting unit.

20. The steering wheel according to claim 11, wherein the plate-shaped tray unit has at least one electrical supply connection for supplying electrical energy to at least one external device or internal device.
